(19) United States
(12) Patent Application Publication
(10) Pub. No.: US 2015/0131215 A1
(43) Pub. Date: May 14, 2015

(54) ELECTRONIC DEVICE SET, TABLET COMPUTER AND SMART WATCH

(71) Applicants: INVENTEC CORPORATION, Taipei City (TW); Inventec (Pudong) Technology Corporation, Shanghai (CN)

(72) Inventor: Shih-Jung HUANG, TAIPEI CITY (TW)

(73) Assignees: INVENTEC CORPORATION, Taipei City (TW); Inventec (Pudong) Technology Corporation, Shanghai (CN)

(21) Appl. No.: 14/226,811

(22) Filed: Mar. 26, 2014

(30) Foreign Application Priority Data
Nov. 11, 2013 (CN) 201310556723.5

(51) Int. Cl. G06F 1/16

(52) U.S. Cl. CPC G06F 1/163; G06F 1/1698; G06F 1/1632
USPC 361/679.03; 361/679.41

(57) ABSTRACT

An electronic device set includes a tablet computer and a smart watch. The tablet computer includes a computer casing, a computer module and at least one computer terminal. The computer casing has at least one connecting slot. The computer module is located in the computer casing. The computer terminal is located in the connecting slot and electrically connected to the computer module. The smart watch includes a watch casing, a watch module and at least one watch terminal. The watch casing is adapted to at least partially couple with the connecting slot. The watch module is located in the watch casing. The watch terminal is exposed from the watch casing, and electrically connected to the watch module. When the watch casing at least partially couples with the connecting slot, the watch terminal is electrically connected to the computer terminal.

### RELATED APPLICATIONS

This application claims priority to Chinese Application Serial Number 201310556723.5, filed Nov. 11, 2013, which is herein incorporated by reference.

### BACKGROUND

1. Field of Invention

The present invention relates to an electronic device set.

2. Description of Related Art

With rapid change of technology, people are more and more relying on electronic devices. Generally, all the electronic devices include both software and hardware. Through the collaborative work of the software and the hardware, demands of multi-functions with growing complexity can be fulfilled.

Most of the electronic devices like tablet computer utilizes default screens as displaying interfaces. Even if the functions of the software are getting more powerful, the default screens cannot be expanded due to the limited spaces of the electronic devices. In the use of some particular software programs or applications, if there is an incoming message, users have to switch the display windows in order to process the message, which causes additional inconveniences.

Compared with the tablet computer, smart watch is the more compact electronic device. Currently, the smart watch and tablet computer usually adopts bluetooth standard for information transmission. However, the bluetooth is more power consuming and relatively unstable in view of the transmission by cable lines.

### SUMMARY

A technical aspect of the present invention provides an electronic device set, to integrate a tablet computer and a smart watch together, such that while the tablet computer and the smart watch can directly transmit information to each other, the smart watch can also act as the auxiliary screen of the tablet computer.

According to an embodiment of the present invention, an electronic device set includes a tablet computer and a smart watch. The tablet computer includes a computer casing, a computer module and at least one computer terminal. The computer casing has at least one connecting slot. The computer module is located in the computer casing. The computer terminal is located in the connecting slot, and electrically connected to the computer module. The smart watch includes a watch casing, a watch module and at least one watch terminal. The watch casing is adapted to at least partially couple with the connecting slot. The watch module is located in the watch casing. The watch terminal is exposed from the watch casing, and electrically connected to the watch module. When the watch casing at least partially couples with the connecting slot, the watch terminal is electrically connected to the computer terminal.

In one or more embodiments of the present invention, the smart watch further includes at least one push button. The push button is disposed on the watch casing. When the watch casing at least partially couples with the connecting slot, the push button snaps witch the connecting slot.

In one or more embodiments of the present invention, the smart watch further includes at least one elastic element. The elastic element connects the push button and the watch module.

In one or more embodiments of he present invention, the smart watch further includes a watch screen. The watch screen is electrically connected to the watch module, has a display surface exposed from the watch casing. When the watch casing at least partially couples with the connecting slot, the display surface is exposed from the connecting slot.

In one or more embodiments of the present invention, the computer terminal is a pogo pin.

According to another embodiment of the present invention, a tablet computer includes a computer casing, a computer module and at least one computer terminal. The computer casing has at least one connecting slot adapted to couple with a smart watch. The computer module is located in the computer casing. The computer terminal is located in the connecting slot, and electrically connected to the computer module. When the connecting slot couples with the smart watch, the computer terminal is electrically connected to at least one watch terminal of the smart watch.

In one or more embodiments of the present invention, the computer terminal is a pogo pin.

According to another embodiment of the present invention, a smart watch includes a watch casing, a watch module and at least one watch terminal. The watch casing is adapted to at least partially couple with a connecting slot of a tablet computer. The watch module is located in the watch casing. The watch terminal is exposed from the watch casing, and electrically connected to the watch module. When the watch casing at least partially couples with the connecting slot of the tablet computer, the watch terminal is electrically connected to at least one computer terminal of the tablet computer.

In one or more embodiments of the present invention, the smart watch further includes at least one push button. The push button is disposed on the watch casing. When the watch casing at least partially couples with the connecting slot of the tablet computer, the push button snaps with the connecting slot of the tablet computer.

In one or more embodiments of the present invention, the smart watch further includes a watch screen. The watch screen is electrically connected to the watch module and has a display surface exposed from the watch casing. When the watch casing at least partially couples with the connecting slot, the display surface is exposed from the connecting slot.

When compared with prior art, the embodiments of the present invention have at least the following advantages:
(1) The aforementioned embodiment of the present invention is that the watch casing at least partially couples with the connecting slot of the computer casing, and the computer terminal is electrically connected to the watch terminal. Thus, the information transmission between the tablet computer and the smart watch can be stably carried out.
(2) The aforementioned embodiment of the present invention is that the watch casing at least partially couples with the connecting slot of the computer casing, and the computer terminal is electrically connected to the watch terminal. Thus, the touch screen of the smart watch can act as the auxiliary screen of the tablet computer. In this way, the screen of the tablet computer can be used for the process of the main program, while the watch screen of the smart watch can be used for message handling or the process of other auxiliary programs.
(3) When the watch casing at least partially couples with the connecting slot of the computer casing, the push button of the smart watch snaps with the connecting slot of the tablet computer. Thus, the coupling and detachment of the tablet computer and the smart watch can be simply carried out.

It is to be understood that both the foregoing general description and the following detailed description are by examples, and are intended to provide further explanation of the present invention as claimed.

### BRIEF DESCRIPTION OF THE DRAWINGS

The invention can be more fully understood by reading the following detailed description of the embodiment, with reference made to the accompanying drawings as follows:

FIG. 1 is a plan view of the electronic device set according to one embodiment of the present invention, in which the tablet computer and the smart watch are in a status of detachment; and

FIG. 2 is a plan view of the electronic device set of FIG. 1, in which the tablet computer and the smart watch are in a status of coupling.

### DETAILED DESCRIPTION

Drawings will be used below to disclose a plurality of embodiments of the present invention. For the sake of clear illustration, many practical details will be explained together in the description below. However, it is appreciated that, the practical details should not be used to limit the present invention. In other words, in some embodiments of the present invention, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

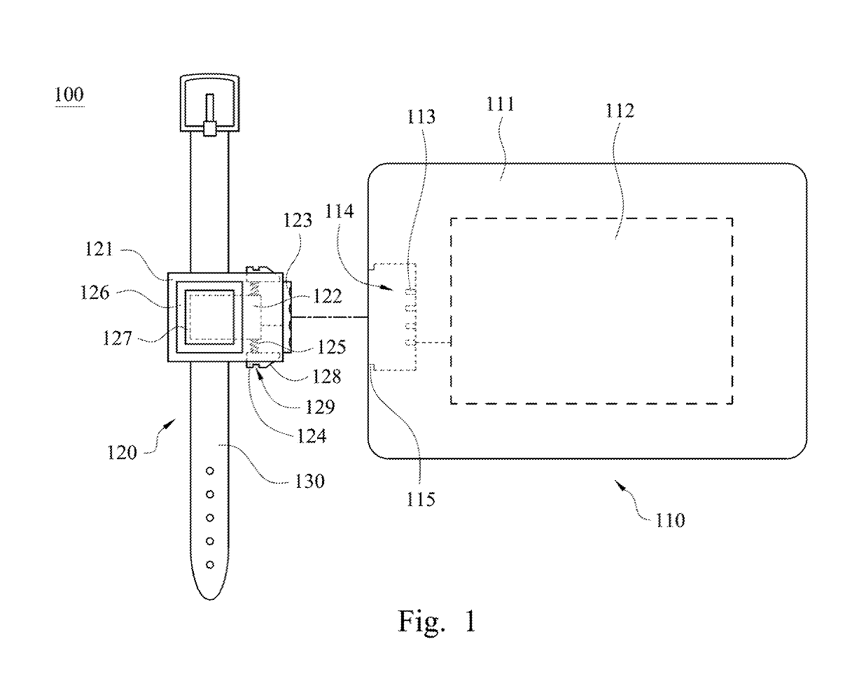

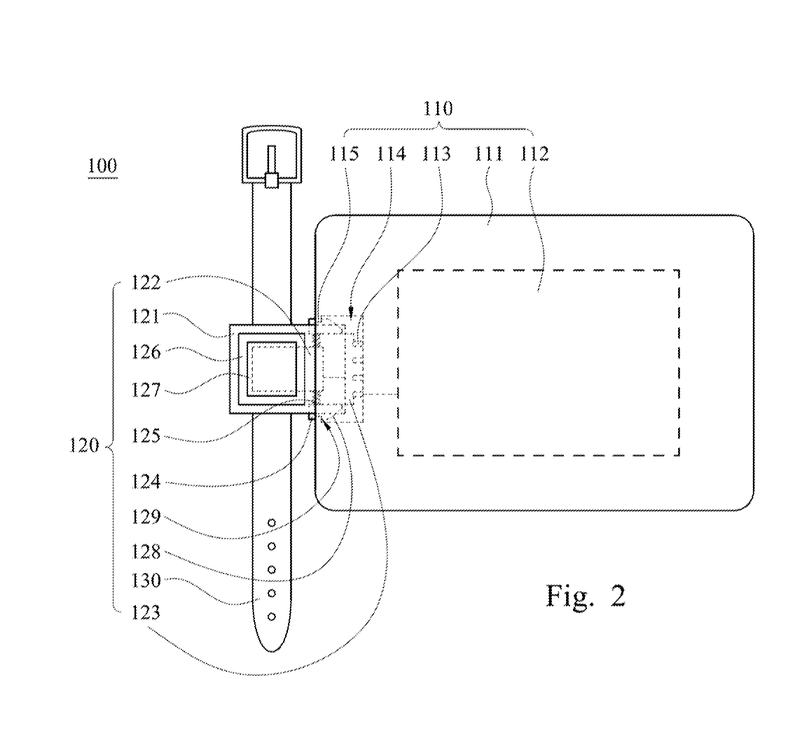

FIG. 1 is a plan view of the electronic device set 100 according to one embodiment of the present invention, in which the tablet computer 110 and the smart watch 120 are in a status of detachment. FIG. 2 is a plan view of the electronic device set 100 of FIG. 1, in which the tablet computer 110 and the smart watch 120 are in a status of coupling. As shown in FIGS. 1˜2 an electronic device set 100 includes a tablet computer 110 and a smart watch 120. The tablet computer 110 includes a computer casing 111, a computer module 112 and at least one computer terminal 113. The computer casing 111 has at least one connecting slot 114 The computer module 112 is located in the computer casing 111. The computer terminal 113 is located in the connecting slot 114, and electrically connected to the computer module 112. The smart watch 120 includes a watch casing 121, a watch module 122 and at least one watch terminal 123. The watch casing 121 adapts to at least partially couple with the connecting slot 114 of the computer casing 111. The watch module 122 is located in the watch casing 121. The watch terminal 123 is exposed from the watch casing 121, and electrically connected to the watch module 122. When the watch casing 121 at least partially couples with the connecting slot 114 of the computer casing 111, the watch terminal 123 is electrically connected to the computer terminal 113. Upon demand, the watch casing 121 can be designed to be detachable from the watchband 130 of the smart watch 120.

For the sake of the coupling and the detachment of the tablet computer 110 and the smart watch 120, the smart watch 120 further includes at least a push button 124. The push button 124 is disposed on the watch casing 121. In this embodiment, as shown in FIGS. 1˜2, the quantity of the push button 124 is a pair, and this pair of push buttons 124 are disposed opposite to each other. The push button 124 has an inclined surface 128, and at least part of the inclined surface 128 is exposed from the watch casing 121.

In order to secure the coupling of the tablet computer 110 and the smart watch 120, the push button 124 further has a recessed part 129. On the push buttons 124 opposite to each other, the respective recessed part 129 faces to the opposite direction of each other. In contrast, the connecting slot 114 of the computer casing 111 has at least a pair of protrusions 115. The pair of protrusions 115 face to each other.

During the coupling of the tablet computer 110 and the smart watch 120, the watch casing 121 of the smart watch 120 is inserted into the connecting slot 114 of the computer casing 111, such that the watch terminal 123 is connected to the computer terminal 113. In the process that the watch casing 121 of the smart watch 120 is ready to be inserted into the connecting slot 114 of the computer casing 111, the inclined surface 128 of the push button 124 first contacts with the protrusion 115 of the connecting slot 114. As the watch casing 121 of the smart watch 120 continues to be inserted into the connecting slot 114 of the computer casing 111, the inclined surface 128 of the push button 124 is under the pressure from the protrusion 115 of the connecting slot 114, such that the push button 124 moves towards the inside of the watch casing 121.

The smart watch 120 further includes an elastic element 125. The elastic element 125 connects the push button 124 and the watch module 122. In this embodiment, as shown in FIGS. 1˜2, the quantity of the elastic element 125 is a pair, both connecting the push button 124 and the watch module 122.

As the watch casing 121 of the smart watch 120 is inserted into the connecting slot 114 of the computer casing 111, the inclined surface 128 of the push button 124 is under the pressure from the protrusion 115 of the connecting slot 114, such that the push button 124 moves towards the inside of the watch casing 121. At this moment, the elastic element 125 is simultaneously under the pressure by the movement of the push button 124, such that the elastic element 125 is compressed and stores an elastic potential energy. Until the inclined surface 128 of the push button 124 passes through the protrusion 115 of the connecting slot 114, the elastic element 125 reaches the maximum compression, and stores the maximum of the elastic potential energy.

As the watch casing 121 of the smart watch 120 continues to be inserted into the connecting slot 114 of the computer casing 111, the recessed part 129 of the push button 124 moves towards the protrusion 115 of the connecting slot 114. At this moment, the elastic element 125 entirely or partially restores to its original length, and provides all or part of the elastic potential energy stored, such that the push button 124 moves towards the outside of the watch casing 121 The recessed part 129 of the push button 124 and the protrusion 115 of the connecting slot 114 snap with each other. In other words, when the watch casing 121 at least partially couples with the connecting slot 114, the push button 124 snaps with the connecting slot 114. Under this condition, the computer terminal 113 is electrically connected to the watch terminal 123. this way, the coupling of the tablet computer 110 and the smart watch 120 can be simply carried out.

In this embodiment, the computer terminal 113 is a pogo pin, and the pogo pin has a telescopic elasticity. Correspondingly, in this embodiment, the watch terminal 123 has a plurality of metallic contact points. The metallic contact points are exposed from the watch terminal 123, and the position matches with the pogo pin of the computer casing 111. With the contact of the pogo pin and the metallic contact points, the computer terminal 113 is electrically connected to the watch terminal 123. Under this status of connection, the pogo pin is compressed and stores an elastic potential energy.

When the smart watch 120 is detached from the tablet computer 110, the user presses on the push button 124, such that the push button 124 moves towards the inside of the watch casing 121, and the recessed part 129 of the push button 124 is detached from the protrusion 115 of the connecting slot 114. In this embodiment, the user presses simultaneously on the push buttons 124 opposite to each other. After the recessed part 129 of the push button 124 is detached from the protrusion 115 of the connecting slot 114, the user pulls out the smart watch 120 from the tablet computer 110. Thus, the electrical connection between the computer terminal 113 and the watch terminal 123 is terminated. At this moment, the elastic element 125 entirely restores to its original length. By the release of the elastic potential energy stored, the push button 124 moves towards the outside of the watch casing 121. In this way, the detachment of the tablet computer 110 and the smart watch 120 can be simply carried out.

When the tablet computer 110 and the smart watch 120 are in the status of coupling, the computer terminal 113 is electrically connected to the watch terminal 123. Through the electrical connection between the computer terminal 113 and the watch terminal 123, the tablet computer 110 and the smart watch 120 can carry out information transmission. Moreover, though the direct physical connection between the computer terminal 113 and the watch terminal 123, the information transmission between the tablet computer 110 and the smart watch 120 can be stably carried out.

Furthermore, through the electrical connection between the computer terminal 113 and the watch terminal 123, the tablet computer 110 and the smart watch 120 can perform the charging function.

As shown in FIGS. 1˜2, the smart watch 120 further includes a watch screen 126. The watch screen 126 is electrically connected to the watch module 122 and has a display surface 127 exposed from the watch casing 121. When the watch casing 121 at least partially couples with the connecting slot 114, the display surface 127 is exposed from the connecting slot 114. Thus, while the user can see clearly the screen of the tablet computer 110, he can also see clearly the whole of the display surface 127 of the smart watch 120.

When the tablet computer 110 and the smart watch 120 are in the status of coupling, the smart watch 120 can act as the auxiliary screen of the tablet computer 110, such that the screen of the tablet computer 110 can be used for the process of the main program, while the watch screen 126 of the smart watch 120 can be used for message handling or the process of other auxiliary programs. For example, when the screen of the tablet computer 110 is occupied due to the use of some particular software or the execution of some particular programs, the display surface 127 of the smart watch 120 can be set as a window to receive messages. While the tablet computer 110 is operated as usual, the user can simultaneously receive and handle instant message through the smart watch 120.

Although the present invention has been described in considerable detail with reference to certain embodiments thereof, other embodiments are possible. Therefore their spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims

What is claimed is:

1. An electronic device set, comprising;
a tablet computer, comprising;
a computer casing, having at least one connecting slot;
a computer module, located in the computer casing; and
at least one computer terminal, located in the connecting slot and electrically connected to the computer module; and
a smart watch, comprising;
a watch casing, adapted to at least partially couple with the connecting slot;
a watch module, located in the watch casing; and
at least one watch terminal, exposed from the watch casing and electrically connected to the watch module; when the watch casing at least partially couples with the connecting slot, the watch terminal is electrically connected to the computer terminal.

2. The electronic device set of claim 1, wherein the smart watch further comprises;
at least one push button, disposed on the watch casing; when the watch casing at least partially couples with the connecting slot, the push button snaps with the connecting slot.

3. The electronic device set of claim 2, wherein the smart watch further comprises:
at least one elastic element, connecting the push button and the watch module.

4. The electronic device set of claim 1, wherein the smart watch further comprises:
a watch screen, electrically connected to the watch module and having a display surface exposed from the watch casing; when the watch casing at least partially couples with the connecting slot, the display surface is exposed from the connecting slot.

5. The electronic device set of claim 1, wherein the computer terminal is a pogo pin.

6. A tablet computer, comprising:
a computer casing, having at least one connecting slot adapted to couple with a smart watch;
a computer module, located in the computer casing; and
at least one computer terminal, located in the connecting slot and electrically connected to the computer module; when the connecting slot couples with the smart watch, the computer terminal is electrically connected to at least one watch terminal of the smart watch.

7. The tablet computer of claim 6, wherein the computer terminal is a pogo pin.

8. A smart watch, comprising:
a watch casing, adapted to at least partially couple with a connecting slot of a tablet computer;
a watch module, located in the watch casing; and
at least one watch terminal, exposed from the watch casing and electrically connected to the watch module; when the watch casing at least partially couples with the connecting slot of the tablet computer, the watch terminal is electrically connected to at least one computer terminal of the tablet computer.

9. The smart watch of claim 8, further comprising:
at least one push button, disposed on the watch casing; when the watch casing at least partially couples with the connecting slot of the tablet computer, the push button snaps with the connecting slot of the tablet computer.

10. The smart watch of claim 8, further comprising:
a watch screen, electrically connected to the watch module and having a display surface exposed from the watch casing; when the watch casing at least partially couples with the connecting slot, the display surface is exposed from the connecting slot.
